(19) United States
(12) Patent Application Publication
(10) Pub. No.: US 2023/0271045 A1
(43) Pub. Date: Aug. 31, 2023

(54) MESH NETWORK FIRE SUPPRESSION SYSTEM AND ASSOCIATED METHODS

(71) Applicant: SPARX TECHNOLOGIES, LLC, Cranston, RI (US)

(72) Inventor: Cassandra Lyn DENUNZIO, Cranston, RI (US)

(21) Appl. No.: 18/099,584

(22) Filed: Jan. 20, 2023

Related U.S. Application Data
(60) Provisional application No. 63/304,302, filed on Jan. 28, 2022.

(51) Int. Cl. A62C 37/10; A62C 37/40; A62C 37/36; A62C 31/02; H04W 84/18

(52) U.S. Cl. CPC A62C 37/10; A62C 31/02; A62C 37/04; A62C 37/40; H04W 84/18

(57) ABSTRACT

A mesh network fire suppression system includes a coordinator node configured as a control unit. The coordinator node includes a transceiver, a processor, and a memory coupled to the processor. In addition, the system includes a plurality of sprinkler nodes configured to be positioned within a building and connected to a water supply, where each of the sprinkler nodes includes a battery as a sole source of power, a wireless transceiver configured to be in communication with the coordinator node, a sensor configured to sense environmental conditions, monitoring circuitry, and actuation circuitry. In addition, each of the sprinkler nodes includes a sprinkler head coupled to the actuation circuitry and configured to dispense water when actuated. The coordinator node is configured to transmit an actuation signal to the actuation circuitry to at least one sprinkler node in response to receiving an alarm message.

### RELATED APPLICATIONS

The present invention is related to U.S. Provisional Pat. Application Serial No. 63/304,302 filed Jan. 28, 2022, the entire contents of which are incorporated herein by reference.

### FIELD OF THE INVENTION

The present invention relates to the field of fire suppressions systems, and more particularly to a mesh network fire suppression system and associated methods.

### BACKGROUND

Commercial and residential buildings are typically outfitted with fire sprinklers that operate mechanically in response to high temperatures. For example, some fire sprinklers are triggered by the melting of a solder link or plug that releases the water flow. Others operate in response to a temperature increase that causes a glass bulb to shatter to release the water flow.

These existing fire sprinklers and systems generally do not communicate with each other to determine which sprinklers are needed to operate in the event of a fire to minimize damage. For example, some buildings may store extremely flammable commodities that may not respond adequately to traditional fire sprinklers that are only triggered locally and independent from one another. Other buildings may have unique architectural elements like obstructions, high ceilings, and sloped ceilings that also make traditional fire sprinkler systems not as effective. Some buildings may have still other unique challenges that make traditional fire sprinklers ineffective.

Accordingly, there is a need in the art for an improved fire suppression system that can address unique challenges of buildings and their contents to minimize damage caused by fire.

### SUMMARY

A mesh network fire suppression system is disclosed. The system includes a coordinator node configured as a control unit. The coordinator node includes a transceiver, a processor, and a memory coupled to the processor. In addition, the system includes a plurality of sprinkler nodes configured to be positioned within a building and connected to a water supply, where each of the sprinkler nodes includes a battery as a sole source of power, a wireless transceiver configured to be in communication with the coordinator node, a sensor configured to sense environmental conditions, monitoring circuitry, and actuation circuitry. In addition, each of the sprinkler nodes includes a sprinkler head coupled to the actuation circuitry and configured to dispense water when actuated. The coordinator node is configured to transmit an actuation signal to the actuation circuitry to at least one sprinkler node in response to receiving an alarm message.

The sprinkler head may include a sprinkler link that is configured to open the supply water when actuated and an electrical trigger coupled to the sprinkler link that is configured to activate the sprinkler link. The sprinkler link may comprise a glass bulb or an alloy link. The electrical trigger may comprise a micro-heater coupled directly to the sprinkler link, a flexible printed circuit (FPC) coupled directly to the sprinkler link and configured as a heater, or a squib. In addition, the electrical trigger may be coupled to the sprinkler link via a mechanical fastener or an adhesive.

The coordinator node is configured to automatically transmit a sleep signal to turn off a particular sprinkler node and a wake signal to turn on the particular sprinkler node in accordance with a pre-defined duration schedule. In addition, the coordinator node is configured to receive environmental conditions data from the plurality of sprinkler nodes. The coordinator node is also configured to selectively transmit an activation signal to respective actuation circuitry of at least one sprinkler node to activate the sprinkler node.

In another particular aspect, a method of suppressing a fire using a mesh network fire suppression system comprising a coordinator node and a plurality of battery operated sprinkler nodes connected to a water supply is disclosed. The method includes transmitting a wireless activation signal from the coordinator node to at least one battery operated sprinkler node of the plurality of battery operated sprinkler nodes to activate a respective sprinkler link. The method also includes using an electrical trigger to activate the respective sprinkler link to open the water supply to suppress a fire.

### BRIEF DESCRIPTION OF THE DRAWINGS

FIG. 1 is a block diagram of a mesh network fire suppression system in which various aspects of the disclosure may be implemented;

FIG. 2 is an exemplary graph of the sleep and wake cycles of sprinkler nodes of FIG. 1;

FIG. 3 is a perspective view of a battery pack for a sprinkler node;

FIGS. 4A and 4B are front and rear views of a micro heater;

FIG. 5 is a perspective view of the micro heater secured to the sprinkler node using adhesive;

FIG. 6 is a perspective view of the micro heater secured to the sprinkler node using a mounting clip;

FIG. 7 is an elevational view of the mounting clip;

FIG. 8 is a front view of the mounting clip of FIG. 7;

FIG. 9 is an elevational view of a terminal junction;

FIG. 10 is a view of a flexible printed circuit (FPC);

FIG. 11 is a perspective view of the FPC of FIG. 10 secured to the sprinkler node using adhesive;

FIG. 12 is a bottom view of housing for electronics of the sprinkler node;

FIG. 13 is a hardware block diagram for the main PCB of FIG. 12;

FIG. 14 is an elevational view of an alternative housing for electronics of the sprinkler node;

FIG. 15 is a bottom view of the shown in FIG. 14;

FIG. 16 is a bottom view of a two-part housing for electronics having integrated teeth;

FIG. 17 is a bottom view of a two-part housing for electronics having retention clips or a snap fit;

FIG. 18 is a schematic showing actuation of fire sprinklers of the mesh network fire suppression system in response to a fire event;

FIG. 19 is a web interface of the system;

FIG. 20 is a block diagram of the sprinkler node and coordinator node of the system;

FIG. 21 is a flow chart of a method implemented by an algorithm of the system;

FIG. 22 is a schematic of the sprinkler node; and

FIG. 23 is a flow chart of a method of using the web interface of FIG. 19 to determine where sprinklers are located within an installation space.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

A mesh network fire suppression system of the present invention is disclosed and generally designated 100. The system 100 includes fire sprinkler heads that are combined with a main printed circuit board (PCB) 106, sensors, communication, and actuation devices to form a sprinkler node 102. The electronic detection component of the sprinkler node can provide a more rapid response to fires than traditional fire sprinkler technology because it allows for the use of multiple sensor types and processing methods as opposed to relying on only a single fixed temperature threshold for activation.

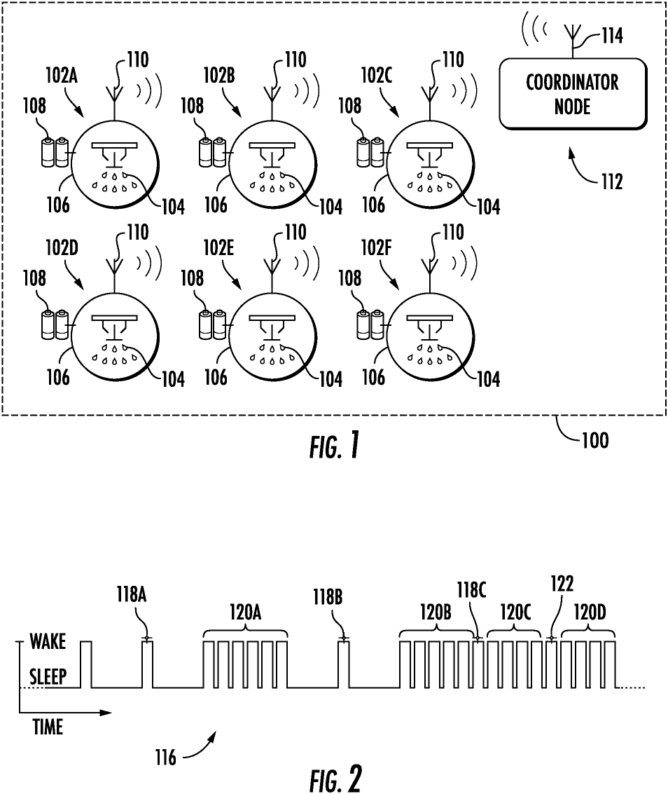

Referring now to FIG. 1, a plurality of sprinkler nodes 102A-F form a network where each sprinkler node can communicate directly with each other and to a coordinator node 112. The coordinator node 112 is the “brain” for the system 100 and the fire sprinkler nodes 102A-F will periodically send status updates to the coordinator node 112. The coordinator node 112 implements an algorithm to trigger the optimal sprinkler heads 104 of the respective sprinkler nodes 102A-F to successfully suppress or extinguish the fire. The coordinator node 112 is configured to control the number of sprinkler operations to not overstress the water supply and to minimize water damage while still achieving suitable suppression or extinguishment. In a particular aspect, the communications network comprises a wireless network of sprinkler nodes 102A-F to make the installation process easier and to save the building owner costs as opposed to a hard wired system.

The mesh network fire suppression system 100 may utilize a mesh protocol such as the one provided by Digi called DigiMesh®. This mesh protocol is specifically designed for low-data rate, low-power applications with fewer complexities than Zigbee®, an alternative mesh protocol, for example. The mesh network provides homogenous node types called routers or “sprinkler nodes.” These sprinkler nodes are capable of battery operation and are unique because they synchronously sleep. The coordinator node 112 in the network is the only node with main power and remains awake. The various sprinkler nodes 102A-F in the network are able to pass along messages through neighboring sprinkler nodes allowing for a true mesh network topology.

As an example of one type of sprinkler node that may be used with the system 100 is the XBee-Pro 900HP RF module (XBee-Pro S3B radio), which provide wireless connectivity to end-point devices (routers) in the mesh network. These modules are FCC Certified (USA), operate on the Industrial, Scientific, and Medical (ISM) band, and are RoHS compliant. The modules are configured in API operating mode so that all data entering and leaving the module is contained in frames that define operations or events within the module.

The sprinkler nodes 102A-F in the network are configured to a synchronous cyclic sleep mode. The coordinator node 112 is configured to a synchronous sleep support mode and does not sleep as explained above. The coordinator node 112 is configured to control when the sprinkler nodes 102A-F in the network sleep and wake. The sprinkler nodes 102A-F stay in a sleep mode for a programmed time, wake in unison with the other sprinkler nodes, exchange data and sync messages, and then return to sleep. The coordinator node 112 stores the sleep and wake times for the sprinkler nodes 102A-F and these sleep and wake times are used to control the network. The aspect of synchronous cyclic sleep is very important because it allows for the sprinkler nodes 102A-F to efficiently operate on battery power. As those of ordinary skill in the art can appreciate, there can be any number of sprinkler nodes and is not limited to the number and configuration described herein.

As explained above, the single point of control is the coordinator node 112. The coordinator node 112 is configured to control decision-making in the event of a fire and to instruct sprinkler operation as needed in the event of a fire. The sprinkler nodes 102A-F may also be configured to make decisions on their own (distributed computing style).

The sprinkler nodes 102A-F will periodically wake up (synchronously) based on the Wake Time (WT) set by the coordinator node 112. The entire network is awake at the same time to guarantee reception of frames and messages. The use of synchronous sleep is exceedingly important to the reliability needed in a fire suppression system to ensure all sprinkler nodes can transmit and receive data at the same time. The synchronous sleep options on these sprinkler nodes 102A-F is also necessary in order to achieve low currents and battery-power performance over reasonable timeframes (e.g., years).

As discussed in more detail below, the system may utilize Lithium Manganese Dioxide batteries to power the sprinkler nodes 102A-F as they are designed for high reliability and safety and are capable of high current discharge performance that is needed for actuating the sprinkler head and they also have a fairly wide temperature operating range for fire conditions (up to 75° C./158° F.). The batteries may be non-rechargeable because industrial primary batteries tend to have a better shelf-life.

Lithium Thionyl Chloride batteries do not have an ideal chemistry for the system due to passivation, which could affect sprinkler actuation. Lithium Poly-Carbon Monoflouride, Lithium Iron Phosphate, Lithium Iron Disulfide, and other Lithium batteries may be used as an option. Battery technology is constantly evolving and improving and may include solid state lithium batteries or other battery chemistries.

As those of ordinary skill in the art can appreciate, many types of batteries can be used and the system is not limited to only those described herein. In addition, a through-hole mounted configuration may be used with a battery pack 113 printed circuit board (PCB). The PCB mounted battery configuration increases the reliability of the system, which requires high reliability.

The manner in which the system 100 controls and utilizes sleep and wake functions is very important to the operation of the battery activated fire sprinkler head 104 and the main PCB 106. Battery powered electronics solve a multitude of problems that arise when installing a hard wired system. Installation costs for the wireless and battery powered system 100 will be much less for material (wire, connectors, conduit, etc.), but especially for labor. The system 100 is also subject to less human error during installation. For example, running multiple wires and troubleshooting shorts, opens, and ground faults across ceilings 35+ feet tall above storage structures between 100+ sprinklers can lead to many errors and difficulty in the installation of a typical hard wired system verses the wireless system.

Referring now to FIG. 2, a graph 116 of the sleep and wake cycles of the sprinkler nodes of the system 100 are illustrated. The sprinkler nodes 102A-F will sleep based on the sleep time (ST) and wake time (WT) set by the coordinator node 112. The sprinkler nodes 102A-F are configured to communicate with the coordinator node 112 using respective transceivers 110. The ST and WT used will be the values for normal operating conditions (ambient temperatures/no fires present). The sleep time for a normal environment may be anywhere from 5 seconds to 60 seconds, for example. At the end of the sleep period the sprinkler nodes 102A-F will wake and their respective sensors such as smoke sensors (photoelectric or ionization) or temperature sensors (thermistors, thermocouples, RTDs, thermopiles, etc.) will be sampled. In addition, the sensors may include infrared sensors such as a flame sensor and/or a gas sensor (carbon dioxide CO2). If the sensor data is considered “normal” or within a certain threshold, the sprinkler nodes 102A-F will go back to sleep for another sleep period.

If instead a pre-alarm condition is met (e.g., a fixed temperature is above a certain threshold or if the temperature has risen at a certain rate or if perhaps a smoke or CO (carbon monoxide) sensor of a particular sprinkler node detects a potentially abnormal condition), then that particular sprinkler node will send a pre-alarm message to the coordinator node 112. The coordinator node 112 will immediately adjust the ST and WT for a “pre-alarm period”. The pre-alarm period will have a shorter sleep time (or no sleep time) and may have a longer wake time to keep the network awake and attentive to a possible pending alarm condition. As those of ordinary skill in the art can appreciate, the sleep time and/or wake time can be configured for particular environmental conditions and physical space for where the system 100 is installed.

For example, if a pre-alarm condition is met at 118A as shown in FIG. 2, then during the subsequent pre-alarm period 120A the sprinkler nodes 102A-F will be waiting to see if an alarm condition is met. If another pre-alarm condition is detected in the pre-alarm period 120A, the pre-alarm period will restart. If no alarm condition is met, and no other pre-alarms have been reported to the coordinator node 112, the pre-alarm period will clear, and the coordinator node 112 will adjust the ST and WT to return the network to normal operating conditions 118B.

If an alarm condition 122 is met in subsequent pre-alarm periods 120B-C after additional pre-alarm conditions 118B-C are met, an alarm message will be sent to the coordinator node 112. The alarm message will indicate that sprinkler actuation needs to take place. Once the coordinator node 112 receives the alarm message, the coordinator node 112 will transmit instructions to the appropriate sprinkler nodes 102A-F instructing them to actuate their respective sprinkler heads 104. The sprinkler nodes 102A-F will stay awake during the alarm period 120D, or continue to wake and sleep with relatively short sleep times, if an alarm message is received by the coordinator node 112.

Each sprinkler node 102A-F may use various sensors to detect pre-alarm and alarm conditions. Data will be collected and examined mathematically. Thermistors or digital temperature sensors may be the primary sensing mechanism to detect temperature values using a single (time, temperature) value, instantaneous rates of change for temperature (first derivative of a temperature vs. time curve – can be calculated using two (time, temperature) values), and the rate of the rate of change for temperature (second derivative of a temperature vs. time curve -calculating using three (time, temperature) values using the difference between two first derivatives divided by half the difference in time between the points.

The instantaneous rate of change is mathematically shown for two (time, temperature) samples below:

$$\frac{d t e m p e r a t u r e}{d t i m e} \vert {}_{\frac{t i m {e}_{1} + t i m {e}_{2}}{2}} = {D}_{1} = \frac{t e m p e r a t u r {e}_{2} - t e m p e r a t u r {e}_{1}}{t i m {e}_{2} - t i m {e}_{1}} \qquad \text{Sample 1: (time1, temperature1) Sample 2: (time2, temperature2)}$$

And the instantaneous rate of change is mathematically shown for Sample 2 and a third (time, temperature) sample, Sample 3, shown below:

$$\frac{d t e m p e r a t u r e}{d t i m e} \vert {}_{\frac{t i m {e}_{2} + t i m {e}_{3}}{2}} = {D}_{2} = \frac{t e m p e r a t u r {e}_{3} - t e m p e r a t u r {e}_{2}}{t i m {e}_{3} - t i m {e}_{2}} \qquad \text{Sample 3: (time3, temperature3)}$$

The above instantaneous rates of change may be used to detect pre-alarm or alarm events. If the instantaneous rate of temperature change is above a certain positive threshold, it can be deduced that temperatures are climbing. The rate of change of the instantaneous rate of change for temperature (second derivative) can also be used as a measure to detect pre-alarm or alarm events because it measures how quickly the rate of rise for temperatures is increasing.

$$\frac{{d}^{2} t e m p e r a t u r e}{d t i m {e}^{2}} \vert {}_{\frac{t i m {e}_{1} + t i m {e}_{3}}{2}} = \frac{{D}_{2} - {D}_{1}}{\left(\frac{t i m {e}_{3} - t i m {e}_{1}}{2}\right)}$$

Smoke sensors, CO2 sensors and/or flame sensors, for example, may also be used to detect pre-alarm and alarm events like photoelectric sensing or ionization sensing. Different sensing technologies and different thresholds for pre-alarm and alarm conditions may be used for different algorithms depending on the application, the environment (warehouse storage facilities, tunnels, atriums, etc.), and the commodity to be protected (plastics, cardboard, aerosols, lithium batteries, other).

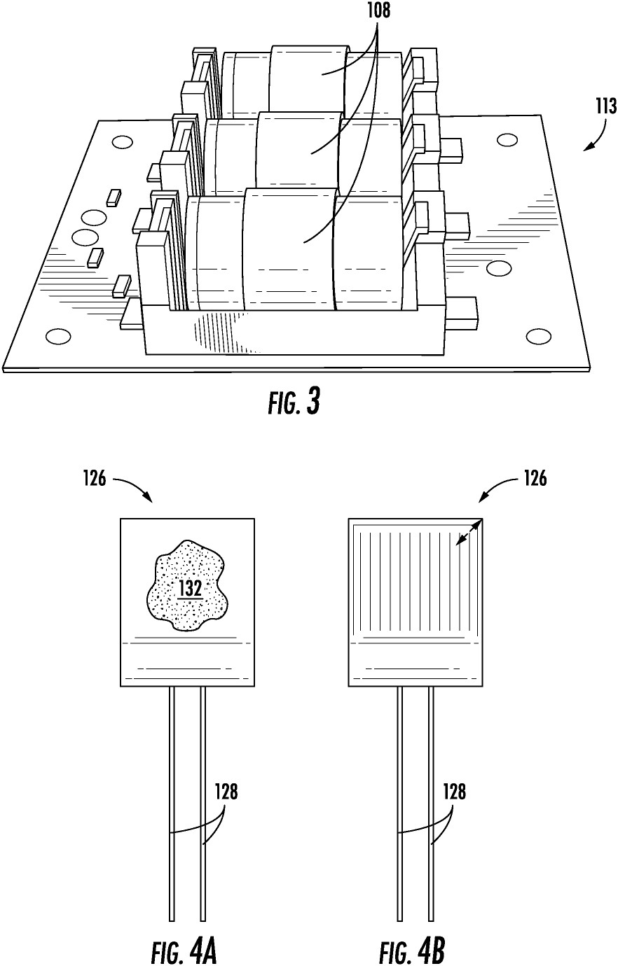

Referring now to FIG. 3, in a particular aspect CR123A Lithium Manganese Dioxide batteries 108 may be used to power the sprinkler nodes 102A-F as they are designed for high reliability and safety and are capable of high current discharge performance (needed for actuating the sprinkler) and they also have a fairly wide temperature operating range for fire conditions (up to 75° C./ 167° F.). These batteries 108 are primary cells and they have a shelf life up to 10 years when stored at 20° C. (90% measured capacity). Non rechargeable lithium batteries are some of the longest lasting primary batteries and have better performance over rechargeable lithium-ion cells with respect to the longer shelf life. Rechargeable lithium-ion batteries generally have high a self-discharge rate and lose the ability to hold charge as they age.

In a particular aspect, the main PCB 106 includes actuation circuitry 124 (and other sensors) and a battery pack 113. The batteries 108 of the battery pack 113 are held in the holders using clips. The clips ensure that the batteries 108 remain securely in their holders. Building owners may replace the entire battery pack 113 with a new battery pack instead of replacing the individual CR123A batteries, for example, located in the battery pack 113. This ensures the use of highly reliable batteries from reliable manufacturers and suppliers and avoids the use of counterfeit batteries or batteries from an unreliable manufacturer. In addition, the battery pack 113 avoids a customer replacing one battery instead of all of the batteries at one time, and avoids using a battery of the same form factor but with a different chemistry.

The battery configuration may include a single string of three CR123A batteries in series, a configuration of a single string of four CR123A batteries, a configuration of two sets (two strings) of three CR123A batteries (totaling 6 batteries), and finally a configuration of two sets (two strings) of 4 CR123A batteries (8 batteries total). These configurations could make up a battery pack of 3 batteries to 8 batteries.

The max continuous discharge current for a single CR123A battery is 1.5A, generally speaking. The maximum pulsed discharge current for these batteries is 3A. Accordingly, two sets of batteries in parallel may be advantageous to actuate with more current if needed. However, the form factor for six or eight batteries may be too large because the battery pack 113 may include an enclosure with a panel mounted connector to clip into and connect to the main printed circuit board 106 with all of the sensors, microcontroller, and communications.

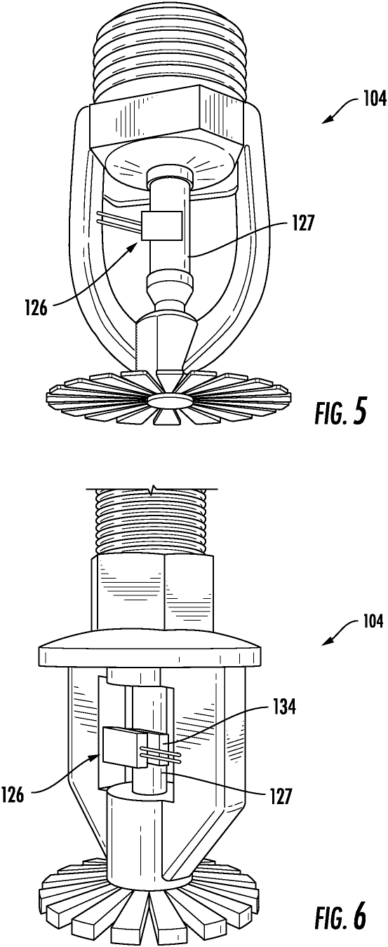

Referring now to FIGS. 4A, 4B and 5, in a particular aspect, an electrical trigger comprising a printed circuit board (PCB) having a micro heater 126 adhered to a sprinkler’s heat-sensitive operating element 127. The heat-sensitive operating element 127 is referred to herein as a “sprinkler link” which may be a bulb or fusible link, for example. The micro heater 126 may be secured to the sprinkler link 127 using an adhesive 132 (e.g., two part epoxy), shrink wrap tubing, small brackets or clamps, or other means. The micro heater 126 includes heating elements such as a platinum thin film heater or the micro heater may be a positive temperature coefficient (“PTC”) heater, for example. The micro heater 126 is electrically coupled to the actuation circuitry 124 via leads 128.

One example of the micro heater 126 is a Heraeus Nexensos H540 S, High-Temperature Platinum (Pt) heater based on DIN EN 60751. The H540 S heater is a platinum thin film heater that combines excellent long term stability with a wide operating temperature range from -25° C. to 800° C. The dimensions of this device are 5.2 mm x 3.9 mm x 1.0 mm. This micro heater has a maximum heating current of 1A and heats up to 700° C. from 25° C. in less than 12 seconds. Considering many sprinkler bulbs operate at 155° F./68.33° C., the heating from Heraeus H540 S micro heater 126 is more than enough to actuate the heat-sensitive sprinkler bulb 127 or fusible link on traditional sprinklers.

With 15 V of applied power from a power supply and with ambient temperature at 20° C., actuation occurred in 10 seconds with the Hereaus micro heater mounted to a 5 mm “standard-response” red bulb 127 (i.e., the sprinkler link) rated for actuation at 155° F. Note that a faster-acting bulb characterized as “quick-response” would actuate sooner. During initial testing with the Heraeus micro heater, the frangible glass bulb 127 shattered to tiny pieces upon actuation and cleared the sprinkler’s waterway.

In the event of detecting a fire, the coordinator node 112 uses its transceiver 114 to transmit a wireless signal to a respective transceiver 110 of the sprinkler nodes 102A-F to operate. In response, the respective actuation circuitry 124 is configured to trigger sprinkler actuation by transmitting sufficient power to the micro heaters 126 via the actuation circuitry 124 to cause the sprinkler link 127 of the respective sprinkler head 104 to break. Capacitors may be used to store energy and these capacitors would be charged by the batteries 108 and discharged to the micro heaters 126.

The micro heaters 126 may include conformal coating for harsh environments as fire sprinklers are subject to moist hydrogen sulfide (H₂S) corrosion testing, moist carbon dioxide sulfur dioxide air mixture (CO₂SO₂) corrosion testing, and salt-spray. For exposed electronics the H₂S corrosion testing may generally be the hardest to pass, and the conformal coating used on the main PCB 106 may be a polyuria, polyurethane, or polyester urethane coating (HumiSeal® 1A65) or another acceptable coating like GE Multilin Harsh Environment Conformal Coating specifically designed for H₂S environments. Preferably any exposed electronics may include the conformal coating or be potted.

The micro heater 126 for each of the sprinkler nodes 102A-F may also include circuitry to determine the integrity of the heating elements. This may be performed by the monitoring circuitry 129 located on the main PCB 106 housed near the sprinkler threads and wrench flats of the respective sprinkler head 104. The monitoring circuitry 129 is coupled to the interface PCB 135 used to provide a connection to the micro heater 126. Conditions monitored will include the presence of shorts, opens, or ground faults.

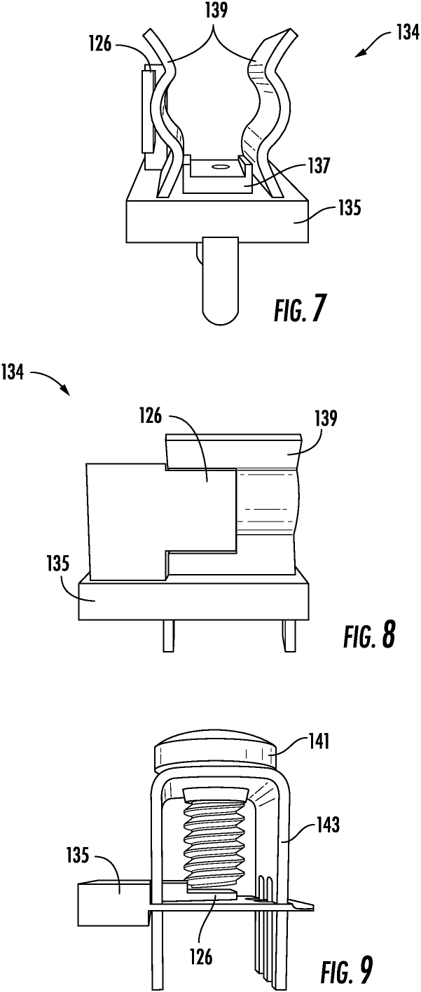

An additional mounting method instead of using epoxy 132 or adhesive directly from the micro heater 126 to the sprinkler link 127 as shown in FIG. 5, is to use a mounting device. The mounting device may include a mounting clip 134 as shown in FIG. 6. The micro heater 126 may be secured to either the inside or outside, to the back or to the side of the mounting clip 134. This may provide an easier method to manufacture and secure the micro heater 126 consistently. The micro heater 126 may be adhered to the mounting clip 134 with a high temperature epoxy or adhesive. High temperature epoxy or adhesive could also be added to the mounting clip 134 before getting secured to the sprinkler link 127 to ensure it stays in place. The mounting clip 134 can be used to transform ordinary glass bulb sprinklers in the field to electronically/battery activated fire sprinklers.

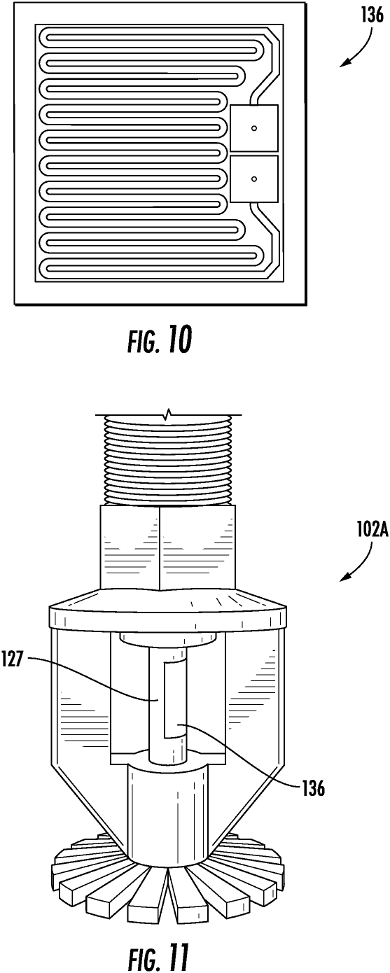

Referring now to FIGS. 7 and 8, the mounting clip 134 includes a pair of opposing tines 139 configured for the sprinkler link 127, such as the sprinkler bulb, to friction fit therebetween. The mounting clip 134 is mounted to a PCB 135. The wires connected to the micro heater 126 also mount to the PCB 135. The PCB 135 also includes a resistor and a diode that are used to monitor the micro heater 126 for shorts opens and ground faults. Wires connect from the PCB 135 to the actuation circuitry 124 and monitoring circuitry 129 housed near the sprinkler wrench-flats so that power can be applied to the micro heater 126 for actuation and the micro heater 126 can also be monitored by the monitoring circuitry 129.

The mounting clip 134 includes a proximity sensor 137 mounted to the PCB 135. The proximity sensor 137 is configured to determine whether the mounting clip 134 is mounted correctly to the sprinkler link 127, which provides reliability to the system 100. The mounting clip 134 can be installed to already existing sprinklers in a retrofit application. The proximity sensor 137 confirms that the installer has properly installed the mounting clip 134 onto the respective sprinkler. The system 100 is configured to generate an alert if the mounting clip 134 has not been installed properly.

Referring now to FIG. 9, the micro heater 126 is secured to the sprinkler link 127 using a terminal junction 143. The sprinkler link (e.g., bulb or fusible link) 127 is inserted through the terminal junction 143 and a set screw 141 is threaded into the terminal junction 143 and tightened to a specified torque to lock the sprinkler link 127 in place against the micro heater 126. The micro heater 126 is mounted to the PCB 135 below the sprinkler link 127 along with a resistor and diode used to monitor for shorts, opens, and ground faults. The interface PCB 135 is also configured to connect via wires to the actuation circuitry 124 and the monitoring circuitry 129 located on the main PCB 106, which is housed at the sprinkler wrench-flats. A small amount of epoxy may be used below the set screw 141 to ensure the set screw 141 fits directly to the sprinkler link 127. Thread locker may also be used for the set screw 141.

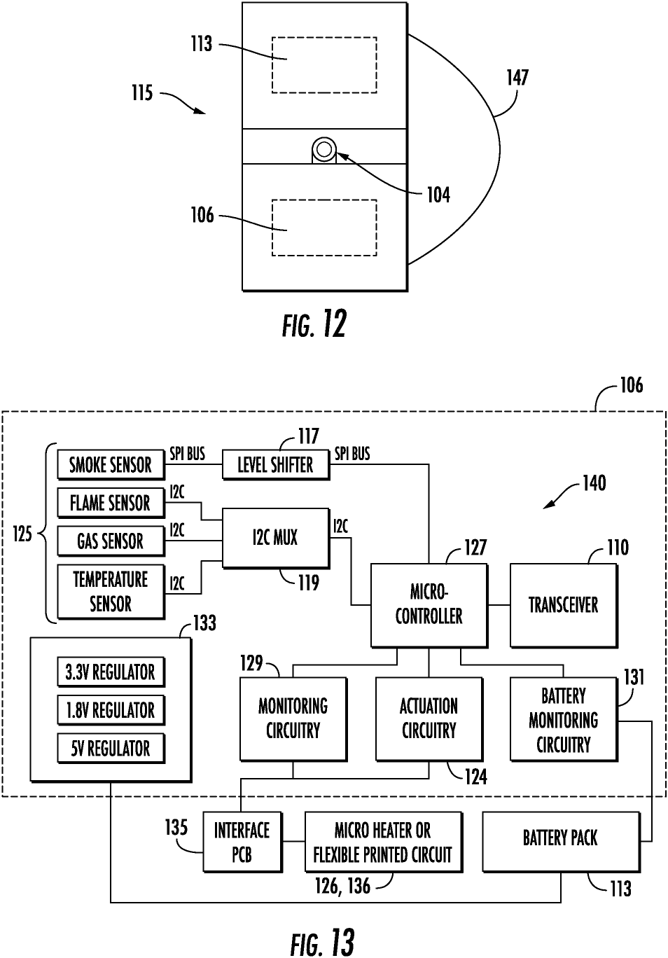

Referring now to FIGS. 10 and 11, in a particular aspect, the electrical trigger comprises a flexible printed circuit 136 (FPC) that is configured as a heater. The FPC 136 can be secured to the sprinkler link 127 on traditional fire sprinkler heads. The FPC 136 is configured to mold around the sprinkler link 127 as shown in FIG. 11. The FPC 136 can be secured to the sprinkler link 127 using heat shrink tubing to slide over the sprinkler link 127 and the FPC 136 with thermally conductive epoxy on the back, for example.

The FPC 136 may have monitoring circuitry for monitoring the integrity of the heating circuitry and monitoring the presence of shorts, opens, or ground faults all completely integrated into a single unit which increases reliability. It also allows for a more reliable solution than trying to make electrical connection to heating coils or other heating elements mounted or present on the outside surface of the sprinkler link 127.

In yet another particular aspect, temperature feedback from the FPC 136 to the actuation circuitry 124 housed near the sprinkler head 104 can be added. The temperature feedback is generated from a thermistor or temperature sensing circuit mounted on the same FPC 136 used for heating. The actuation circuitry 124 may be configured to adjust a pulse width modulation output signal to pulse the voltage applied to the micro heater 126 so the FPC 136 does not overheat. This ensures that the FPC 136 stays within the acceptable operating temperature range.

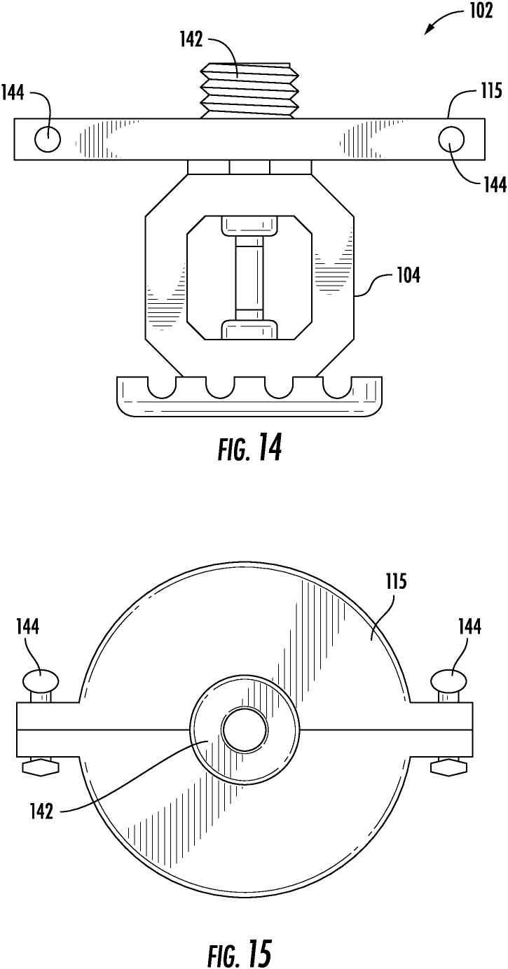

Referring now to FIG. 12, a bottom view of a three-part housing 115 for electronics of the sprinkler node is shown. A wiring harness 147 couples the battery pack 113 to the main PCB 106. After securing the housing 115 around the sprinkler head 104, an installer would connect the wiring harness 147 to a panel mounted connector on the main PCB 106. In a particular aspect, snap fit joints hold the three parts of the housing together 115. The main PCB 106 for each of the sprinkler nodes 102A-F includes a plurality of circuitry and sensors among other components. The housing 115 could also be mounted to the side and separate from the sprinkler head 104, for example, instead of around the sprinkler head 104. A block diagram 140 of the main PCB 106 is shown in FIG. 13.

The main PCB 106 includes a plurality of sensors 125 coupled to a microcontroller 127 via a level shifter 117 and a multiplexor 119. The microcontroller 127 is also coupled to monitoring circuitry 129, the actuation circuitry 124 and battery monitoring circuitry 131. The micro heater 126 or FPC 136 is coupled to the actuation circuitry 124 and the monitoring circuitry 129 via an interface PCB 135. The battery monitoring circuitry 131 is coupled to the battery pack 113, which is coupled to a plurality of regulators 133. As explained above, the transceiver 110 that is coupled to the microcontroller 127 is configured to communicate with the coordinator node 112 via transceiver 114.

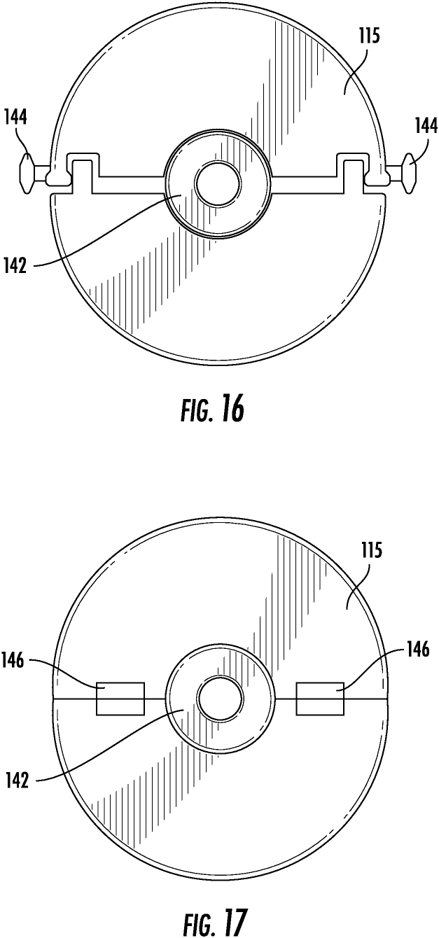

Referring now to FIG. 14, a housing 115 is configured to contain the electronics and batteries and to be secured to the sprinkler head 104. The housing 115 may be secured at the bottom of the sprinkler head threads 142 above the wrench flats. The housing 115 protects the electronics from damage, especially during installation. The housing 115, except for the antenna for the transceiver 110, batteries 108, and other sensors 125 may be potted for protection. The batteries 108, antennae 110, and sensors 135 (e.g., thermistors) may be excluded from the potting as needed.

The housing 115 may comprise a battery compartment that is accessible to change batteries 108 or the battery pack 113 as needed. The housing 115 may be fully integrated with the sprinkler head 104 for installation. In addition, for future ease of replacements without having to drain the entire sprinkler system of water, the housing 115 may be detachable with unique fasteners 144. The fasteners 144 (e.g. screws) are tamper-proof per fire protection standards and codes. The detachable nature of the housing 115 is helpful for the need to replace the electronics over time. Using electronics in the fire sprinkler industry is relatively new so that it is likely that insurance and approval agencies will require the testing and replacement of electronics at more frequent increments than the sprinkler components to comply with regulations and standards.

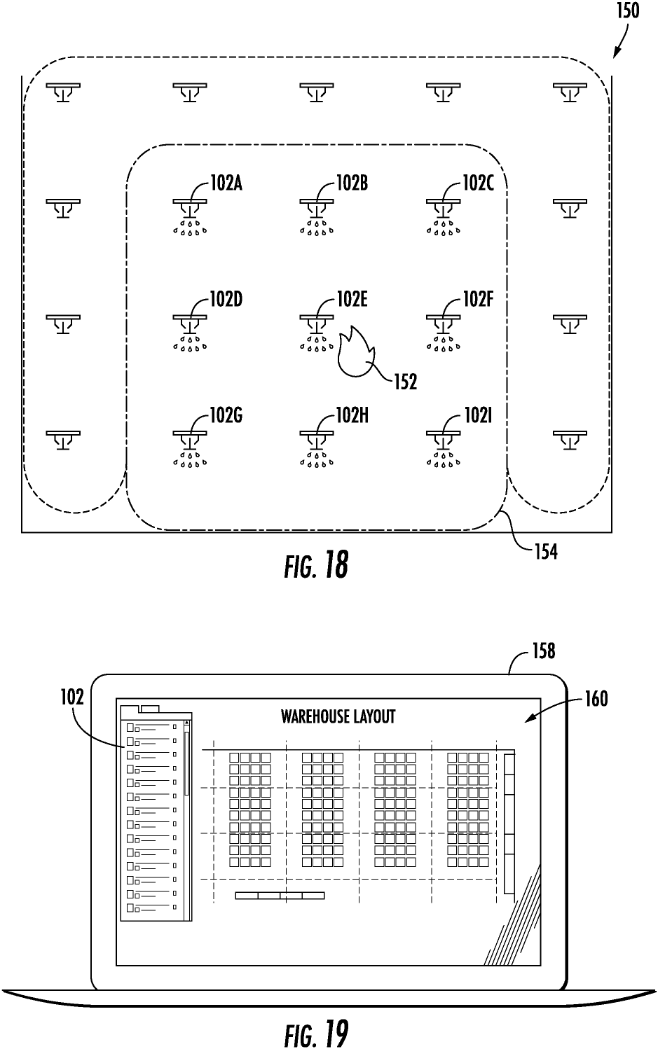

Referring now to FIG. 15, the housing 115 may comprise a two-piece assembly that is coupled together. The two-part housing may be curved/circular, rectangular or another shape. In another aspect, the housing 115 includes integrated teeth that fit together as illustrated in FIG. 16.

In another aspect, the housing 115 uses retention clips 146 to secure one side of the housing 115 into the other, instead of screws as illustrated in FIG. 17. The retention clips 146 hold the two pieces of the housing 115 together. One retention clip 146 or two may be used to properly lock the housing 115 into place around the sprinkler head threads 142. If one retention clip 146 is used on one side of the housing 115, the opposite side may utilize a single screw 144 borrowing from the designs in FIG. 14 and FIG. 15. Using the retention clips 146 helps to utilize the space on both sides of the housing 115. For example, the batteries 108 may be housed on one side and the rest of the electronics on the other side of the housing 115.

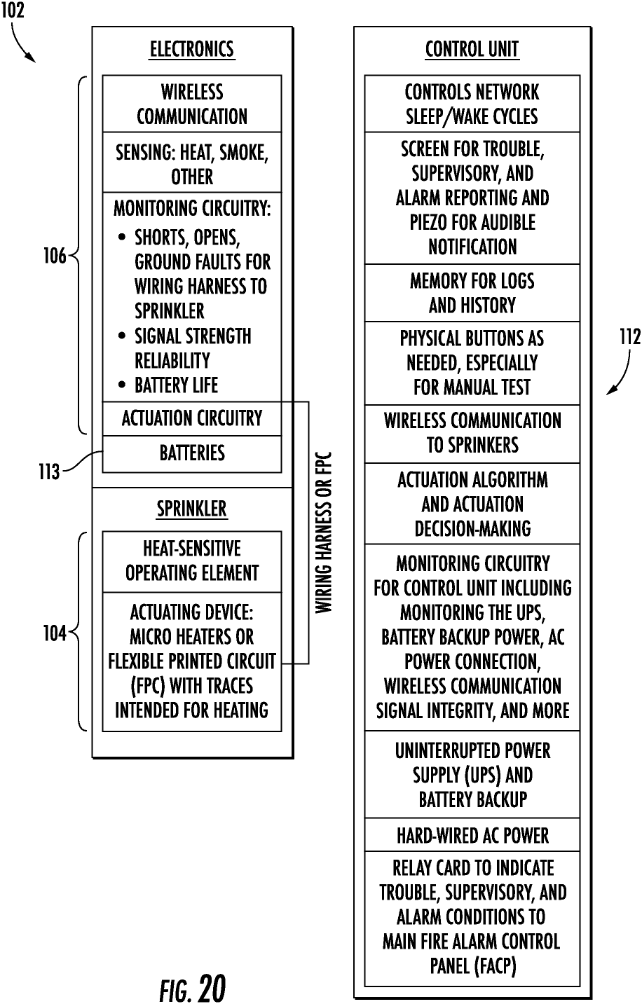

Referring now to FIG. 18, an important aspect of the system 100 is for the coordinator node 112 to understand where various sprinkler nodes are located in space. In the event of a fire 152, a group of sprinklers 154 (e.g., sprinkler nodes 102A-102I) may be instructed to act simultaneously to properly target the fire centroid. Sprinklers directly above a fire in addition to those proximate sprinklers may be employed to fight the fire. FIG. 18 shows an example of grouped actuation. As explained above, each sprinkler node includes actuation circuitry 124 that is used to activate the sprinkler head to dispense water. In FIG. 18, the alarm condition originated at the sprinkler node 102E directly above the fire 152, and the coordinator node 112 made the decision to actuate that sprinkler head of sprinkler node 102E and the surrounding sprinklers within group 154. In order to do that, the coordinator node 112 retrieves data as to where sprinklers are located in relation to each other and the fire.

The system 100 uses a web interface 158 to program and store the data of the sprinkler locations. Referring now to FIG. 19, the web interface 158 of the system 100 is configured so that an installer can upload a floor plan 160, overlay a snap grid that aligns (snaps) objects during drawing and editing, and use a drag and drop menu 162 to place sprinkler nodes onto the grid to correlate to the exact position that they are located in a building. The snap grid will assist with placing sprinkler nodes precisely on the grid by arranging objects to the closest intersections on the grid. The web interface 158 pushes the position data back to the network (specifically the coordinator node) so the network can use the position data to make decisions.

The web interface 158 is configured so that the installer can make changes and deploy updates easily and as needed. It also is configured to provide a customized solution to implement a snap grid onto the static floor plan which is something that has not been available previously. The snap grid will allow for easier and more accurate placement of the sprinkler nodes because sprinkler systems are generally grid layouts.

The web interface 158 is configured for the installer to drag and drop sprinkler nodes onto the uploaded building plan layout 158, turn the snap grid on and off, and adjust the snap grid. The installer may need to specify an actual distance between two points on the building plan layout in order for the web interface to calibrate distances. The web interface 158 may obtain location by calculating actual distances based on this information or it may use distance information in the form of pixel location. Sprinklers will be able to be added using the web interface 158 in 2-D space for ceiling-only sprinkler protection, and in the alternative application of in-rack sprinkler protection, sprinklers will be able to be added using the web interface in 3-D space. Distance and positioning information that describes the sprinkler locations will be obtained and communicated to the coordinator node.

In addition, the web interface 158 is also configured for installers to turn on a test LED for individual sprinkler nodes or rows/columns of sprinkler nodes. This will allow installers to confirm the mapped devices on the interface match up to the installed devices. An Application Programming Interface (API) of the system 100 is configured so that the web interface 158 can display sprinkler nodes and map devices and communicate positioning information back to the coordinator node 112. The API will serve as the intermediary that will allow the installer to communicate and program the coordinator node 112. The API will allow sprinkler node positioning information that is input by the installer to be communicated to the coordinator node 112. The coordinator node 112 will need this positioning information when making sprinkler actuation decisions and determining the optimal sprinklers needed for operation in the event of a fire. The web interface 158 may display 2-D or 3-D depending in the sprinkler configuration and application.

As explained above, the coordinator node 112 is configured as the main decision-making entity in the system 100 and serves as the “Control Unit” as defined by the relevant National Fire Protection Association (NFPA) Codes and Standards. The coordinator node 112 will make sprinkler actuation decisions and control when the network “sleeps,” but it also has many more responsibilities. Based on NFPA Codes and Standards, the coordinator node 112 will also be configured to send trouble, supervisory, and alarm signals via a relay card (open/closed contacts) to the building’s main fire alarm control panel (FACP).

The coordinator node 112 is also configured to display trouble, supervisory, and alarm notifications and auditory notifications as needed. The coordinator node 112 constantly monitors the integrity of the network and if a connection link from the coordinator node 112 to any of the sprinkler nodes is broken, a supervisory signal will be reported. If actuation circuitry on a particular sprinkler node is compromised, a supervisory signal will be reported. If sprinkler node batteries are low this will be reported as a trouble. The coordinator node 112 (i.e. control unit) includes an uninterrupted power supply (UPS) with battery back-up for 90-hours, for example.

The system 100 also includes various physical switches. For example, a switch is configured to allow for a bypass-testing mode to prevent sprinkler actuation during testing.

The coordinator node 112 may be connected to the cloud to allow for access to data from sprinkler nodes and the coordinator node including battery status, temperatures, and other sensor measurements. Cloud connectivity may not be a critical component of the network in terms of decisions made by the coordinator node 112 for sprinkler actuation but may be used for overall maintenance and insight to the health of the network.

The present system 100 controls sprinkler operations rather than allowing sprinklers to operate solely in response to heat from a fire. However, the system 100 does not replace the ability for the sprinklers to respond to heat from a fire, rather the system provides that a sprinkler can be selectively activated before it would in response to heat of a fire. It is preferable to operate the sprinklers using instructions received from the coordinator node 112, and not solely based on heat in order to improve the use of water to be the most advantageous to supress a fire. The system 100 is configured to determine the optimal sprinkler group needed to suppress the fire and activate this group of sprinklers all at once. This method allows for maximal water discharge density over the flaming area and nearby vicinities in the event of a fire. It is difficult to make optimal and efficient actuation decisions post-initial-operation because sprinklers can provide cooling once they operate in surrounding areas.

Sprinklers that are nearby operating sprinklers can also be affected by a phenomenon called water droplet impingement which can slow or prevent these nearby sprinklers from operating. Water droplet impingement is caused by water droplets from adjacent sprinklers splashing and cooling the heat-sensitive components and prevents the sprinkler from being actuated. The system 100 improves fire suppression by determining which sprinklers are needed, and to actuate those sprinklers all at once. Actuating a group of sprinklers around fire origin all at once also allows for a proactive approach to prevent fire spread by pre-wetting the areas adjacent to the flaming area.

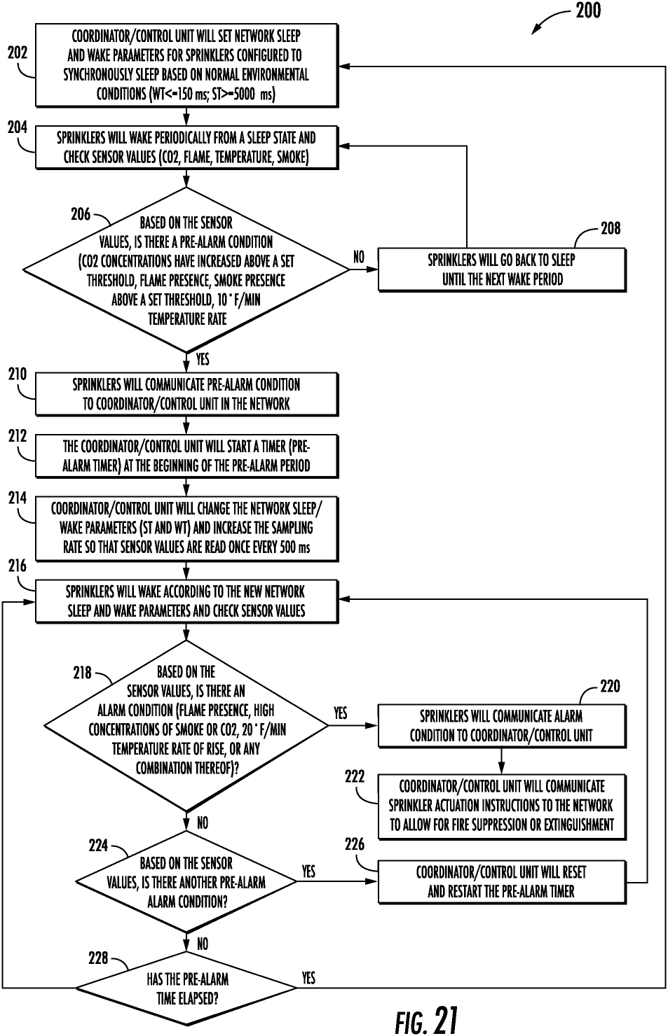

Referring now to FIG. 20, a general block diagram of the components of the sprinkler node 102 and the coordinator node 112 are illustrated. For example, the sprinkler node 112 may include electronic components and sprinkler components. As discussed above, the electronic components 106 include wireless communication circuitry, sensing circuitry, monitoring circuitry, actuation circuitry and batteries. The sprinkler components include the sprinkler head 104, heat-sensitive sprinkler link, and an actuating device such as a micro heater or FPC, among other things.

The coordinator node 112 includes a memory coupled to a processor. The coordinator node 112 (i.e., control unit) is configured to control the network sleep/wake cycles, screen for trouble, supervisory, and alarm reporting and piezo for audible notification. The memory stores logs and history of the system operations. The coordinator node 112 also includes physical buttons as needed for manual testing, for example. The coordinator node 112 is in wireless communication with the sprinkler nodes and includes an actuation algorithm and actuation decision making programming. The coordinator node 112 includes a UPS and battery backup and is hard-wired with AC power. The coordinator node 112 includes monitoring circuitry for monitoring the UPS, battery backup, ac power connection, and wireless communication integrity, among other things. In addition, the coordinator node 112 has wired communication to the main fire alarm control panel (FACP) .

Referring now to FIG. 21, a flowchart 200 of a method implemented by an algorithm for setting and adjusting sleep times and wake times of the sprinkler nodes is shown. The coordinator node 112, at 202, sets sleep and wake parameters for the sprinkler nodes 102A-F to synchronously sleep based on normal environmental conditions (e.g., WT<=150 ms; ST>=5000 ms). The sprinkler nodes 102A-F will wake periodically from a sleep state and check sensor values (e.g., CO2, flame, temperature, smoke), at 204.

Based on the sensor values, the system determines if there is a pre-alarm condition (e.g., CO2 concentrations have increased above a set threshold, flame presence, smoke presence above a set threshold, 10° F./min temperature rate), at 206. If there is no pre-alarm condition, then the sprinklers will go back to sleep until the next wake period, at 208.

If there is a pre-alarm condition detected, then, at 210, the respective sprinkler node will communicate the pre-alarm condition to the coordinator node 112. In response, the coordinator node 112 will start a timer (pre-alarm timer) at the beginning of the pre-alarm period, at 212. The coordinator node 112, at 214, will change the network sleep/wake parameters (ST and WT) and increase the sampling rate so that sensor values are read once every 500 ms, for example. The sprinkler nodes 102A-F will wake according to the new network sleep and wake parameters, at 216, and check sensor values to transmit to the coordinator node 112.

Based on the sensor values, the system determines if there is an alarm condition (flame presence, high concentrations of smoke or CO2, 20° F./min temperature rate of rise, or any combination thereof), at 218. If there is alarm condition, the sprinkler node will, at 220, communicate the alarm condition to the coordinator node 112. In response to receiving the alarm condition communication from the respective sprinkler node, the coordinator node 112 will communicate sprinkler actuation instructions, at 222, to designated sprinkler nodes to discharge water. The actuation of the sprinkler heads is in accordance to that described above with respect to using micro heaters or FPCs. If there is not an alarm condition, the sprinkler node will, at 224, determine if there is at least a pre-alarm condition. If there is a pre-alarm condition, then the coordinator node 112 will, at 226 reset and restart the pre-alarm timer for the respective sprinkler nodes and return to block 216. If there is not a pre-alarm condition detected at 224, and if the pre-alarm timer has elapsed, at 228, then the system returns to block 202. If there is not a pre-alarm condition detected at 224, but the pre-alarm timer has not elapsed, then the system returns to block 216.

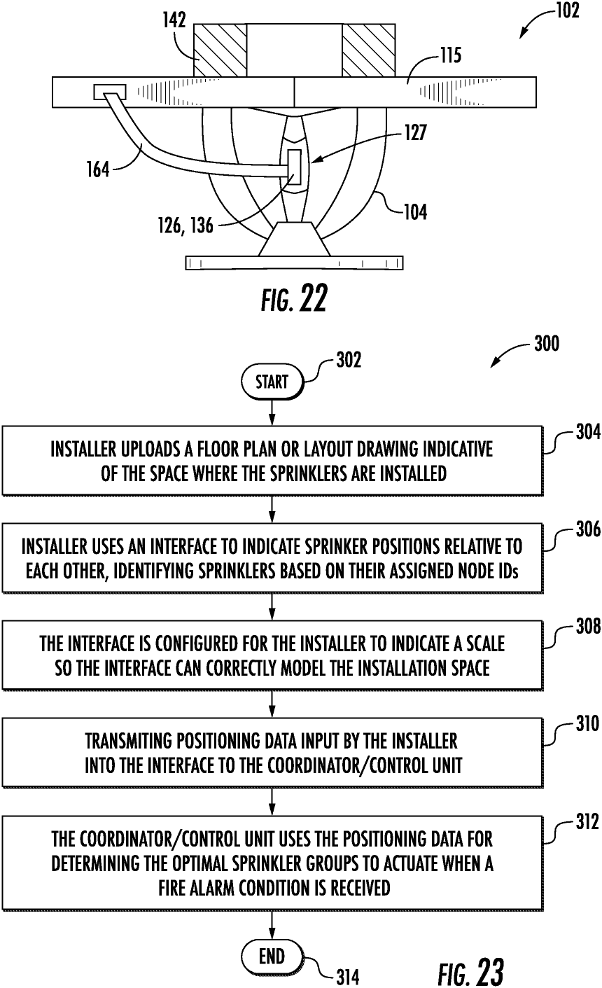

Referring now to FIG. 22, a schematic of a typical sprinkler node 102 of the system 100 is illustrated having the electronics coupled to the sprinkler link 127 via wires 164. The electronics are in the housing 115 located above the sprinkler head 104 proximate the sprinkler head threads 142. The sprinkler link 127 may be a heat sensitive operating element such as a glass bulb that contains a heat sensitive liquid or a fusible link, for example, that can be activated by a micro heater 126 or FPC 136 to initiate the flow of water from the sprinkler as described above.

FIG. 23 is a general flowchart for a method of how the web interface 158 may be used to set up the coordinator node 112 to control the sprinkler nodes 102A-F. The method begins at 302 and, at 304, an installer uploads a floor plan or layout drawing indicative of the space where the sprinklers are installed. The installer will, at 306, use the web interface to map sprinkler positions relative to each other, identifying sprinklers based on network parameters like their assigned Node IDs or Serial Numbers. The web interface 158 is configured for the installer to indicate a scale, at 308, so the web interface 158 can correctly model the installation space. Moving to 310, the method includes transmitting positioning data input by the installer into the web interface 158 to the coordinator node 112. The coordinator node 112 uses the positioning data, at 312, for determining the optimal sprinkler groups to actuate when a fire alarm condition is received. The method ends at 314. It is important for the coordinator node 112 to have data that represents where sprinklers are located in space so the coordinator node 112 can actuate groups of sprinklers in the same relative vicinity to effectively suppress or extinguish a fire.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A mesh network fire suppression system, the system comprising:
a coordinator node configured as a control unit, the coordinator node comprising,
a coordinator node wireless transceiver,
a processor,
a memory coupled to the processor; and
a plurality of sprinkler nodes configured to be positioned within a building and connected to a water supply, each of the sprinkler nodes comprising,
a battery as a source of power,
a sprinkler node wireless transceiver configured to be in communication with the coordinator node,
a sensor configured to sense environmental conditions,
actuation circuitry, and
a sprinkler head coupled to the actuation circuitry and configured to dispense water when actuated;
wherein the coordinator node is configured to transmit an actuation signal to the actuation circuitry to at least one sprinkler node in response to receiving an alarm message.

2. The system of claim 1, wherein the sprinkler head comprises a sprinkler link configured to open the supply water when actuated.

3. The system of claim 2, wherein the actuation circuitry comprises an electrical trigger coupled to the sprinkler link and configured to activate the sprinkler link.

4. The system of claim 3, wherein the sprinkler link comprises a glass bulb.

5. The system of claim 3, wherein the sprinkler link comprises an alloy link.

6. The system of claim 3, wherein the electrical trigger comprises a micro-heater coupled directly to the sprinkler link.

7. The system of claim 3, wherein the electrical trigger comprises a flexible printed circuit (FPC) coupled directly to the sprinkler link and configured as a heater.

8. The system of claim 3, wherein the electrical trigger further comprises a temperature sensing circuit configured to provide feedback to the processor.

9. The system of claim 3, wherein the electrical trigger comprises a squib coupled to the sprinkler link.

10. The system of claim 3, wherein the electrical trigger is coupled to the sprinkler link via a mechanical fastener.

11. The system of claim 3, wherein the electrical trigger is coupled to the sprinkler link via an adhesive.

12. The system of claim 1, wherein the coordinator node is configured to automatically transmit a sleep signal to turn off a particular sprinkler node and a wake signal to turn on the particular sprinkler node in accordance with a pre-defined duration schedule.

13. The system of claim 3, wherein the coordinator node is configured to receive environmental conditions data from the plurality of sprinkler nodes and configured to selectively transmit in response thereof an activation signal to respective actuation circuitry of at least one sprinkler node.

14. A sprinkler node comprising:
a housing;
a battery stored within the housing;
a sensor configured to sense environmental conditions;
actuation circuitry;
a wireless transceiver configured to be in communication with a coordinator node and to receive an actuation signal; and
a sprinkler head coupled to the actuation circuitry and configured to dispense water when actuated.

15. The sprinkler node of claim 14, wherein the sprinkler head comprises a sprinkler link configured to open supply water when actuated.

16. The sprinkler node of claim 15, wherein the actuation circuitry comprises an electrical trigger coupled to the sprinkler link and configured to activate the sprinkler link.

17. The sprinkler node of claim 16, wherein the sprinkler link comprises a glass bulb or an alloy link.

18. The sprinkler node of claim 16, wherein the electrical trigger comprises a micro-heater coupled to the sprinkler link or a flexible printed circuit (FPC) coupled to the sprinkler link and configured as a heater.

19. The sprinkler node of claim 16, wherein the electrical trigger is coupled to the sprinkler link via a mechanical fastener or an adhesive.

20. A method of suppressing a fire using a mesh network fire suppression system comprising a coordinator node and a plurality of battery operated sprinkler nodes connected to a water supply, the method comprising:
transmitting a wireless activation signal from the coordinator node to at least one battery operated sprinkler node of the plurality of battery operated sprinkler nodes to activate a respective sprinkler link; and
using an electrical trigger to activate the respective sprinkler link to open the water supply to suppress a fire.
